(19) United States
(12) Patent Application Publication
(10) Pub. No.: US 2021/0362800 A1
(43) Pub. Date: Nov. 25, 2021

(54) Retractable Towing Device

(71) Applicant: Tabitha Bane, Watsonville, CA (US)

(72) Inventor: Tabitha Bane, Watsonville, CA (US)

(21) Appl. No.: 17/325,492

(22) Filed: May 20, 2021

Related U.S. Application Data
(60) Provisional application No. 63/027,460, filed on May 20, 2020.

(51) Int. Cl. B62K 27/12

(52) U.S. Cl. CPC B62K 27/12

(57) ABSTRACT

In another embodiment, a towing system for a pair of bicycles is described. The towing device includes a towing device comprising a tow rope retractably contained within a canister and a mounting surface proximate a top of the canister. The towing device also includes at least one fastener positioned to affix the mounting surface to an underside of a bicycle seat and a towing latching coupled to the free end of the tow rope. The towing system also includes a towee device. The towee device includes a second tow rope with a first end and a second end and a first ring attached to the first end of the second tow rope and a second ring attached to the second end of the second tow rope. The first and second ring are coupled to a connecting tow rope at a first end and a second towing latch couple to the rigid tow rope at a second end, wherein the towing latch of the towee device removably couples to the towing latch.

### CROSS-REFERENCE TO RELATED PATENT APPLICATIONS

This patent application claims benefit of U.S. Provisional Patent Application No. 63/027,460 filed May 20, 2020 and is incorporated herein by reference in their entirety for all purposes.

### BACKGROUND

Bicycling often requires the cyclist to climb terrain such as hills, ramps, and other inclines. However, not all cyclists have the strength to climb terrain. Children often struggle with hills, especially longer climbs. However, parents often want their children to exercise and get fresh air and enjoy the sport without demounting their bicycle and pushing it up the hill, which can also be challenging for children's strength, stamina, and enjoyment. The child may benefit from having some assistance to reach the top of the terrain.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a towing device for a bicycle is described. The towing device includes a tow rope retractably contained within a canister and a mounting surface proximate a top of the canister. At least one fastener is positioned to affix the mounting surface to an underside of a bicycle seat.

In some embodiments, the towing device may include a top plate removably coupled to the mounting surface via the one or more fasteners. In some embodiments, the top plate may have a first side and a second side opposite the first side. The first side may be hingedely coupled to the mounting surface and the second side may be removably coupled to the mounting surface via the one or more fasteners. In some embodiments, a latch may be coupled to the tow rope. The latch may include a magnetic material. In some instances, a magnet may be coupled to an outside of the canister, wherein the latch may be removably coupled to the magnet. In some embodiments, the mounting surface may include a substantially planer mounting plate affixed to the canister. In some embodiments, the at least one fastener may include a quick connect fastener.

In another embodiment, a towing device for a bicycle is described. The towing device includes a towee strap with a first end and a second end and a first ring attached to the first end of the elasticized rope and a second ring attached to the second end of the towee strap. The first and second ring are coupled to a connector rope at a first end and a towing latch couple to the connector rope at a second end. In some embodiments, a clip may be proximate the first end of the second, rigid tow rope, wherein the clip removably couples to the first ring. In some embodiments, the towee rope has a variable length. In some embodiments, the towing device has a second towee strap. In some instances, at least a portion of the towee strap comprises an elastic material. A nylon cover may cover the elasticized tow rope. The towing latch may include a clip, latch, or some combination thereof.

In another embodiment, a towing system for a pair of bicycles is described. The towing device includes a towing device comprising a tow rope retractably contained within a canister and a mounting surface proximate a top of the canister. The towing device also includes at least one fastener positioned to affix the mounting surface to an underside of a bicycle seat and a towing latching coupled to the free end of the tow rope. The towing system also includes a towee device. The towee device includes a second tow rope with a first end and a second end and a first ring attached to the first end of the second tow rope and a second ring attached to the second end of the second tow rope. The first and second ring are coupled to a connecting tow rope at a first end and a second towing latch couple to the rigid tow rope at a second end, wherein the towing latch of the towee device removably couples to the towing latch.

In some embodiments, the towing device includes a top plate and at least one fastener coupling the top plate to the canister. In some embodiments, the top plate and at least one fastener may clamp the canister to at least one seat rail of a bicycle. In some embodiments, at least a portion of the first two rope is flexible. In further embodiments, at least a portion of the second tow rope is flexible.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein:

FIG. 1 is a diagram of a sample bicycle in accordance with exemplary embodiments described herein;

FIG. 2 is a diagram of an example bicycle seat in accordance with exemplary embodiments described herein;

FIG. 3 is a diagram of sample embodiments of components of a towing system in accordance with exemplary embodiments described herein;

FIG. 4 is a diagram of sample embodiments of components of a towing system in accordance with exemplary embodiments described herein; and

FIG. 5 is a diagram of sample embodiments of components of a towing system in accordance with exemplary embodiments described herein.

### DETAILED DESCRIPTION

The systems and methods described herein relate to cycling. More specifically, the systems and methods described herein relate to a way for towing a second bicycle. For example, when biking, the ground is not always flat. Often times there are ramps, hills, or other inclines to climb during the ride. This may present a challenge to lesser capable riders such as children. An older rider may pull a younger, less capable rider up the climb and continue bicycling by attaching a tow rope between the two riders or bicycles. However, during downhill terrain or flat terrain, the less capable rider may not require assistance, and therefore, the tow rope may need to be safely stowed. Using an actual rope can present difficulties and be cumbersome to take out, affix, and remove continuously.

In the following description, specific details are set forth to provide a thorough understanding of exemplary embodiments of the present disclosure. However, it will be apparent to one skilled in the art that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

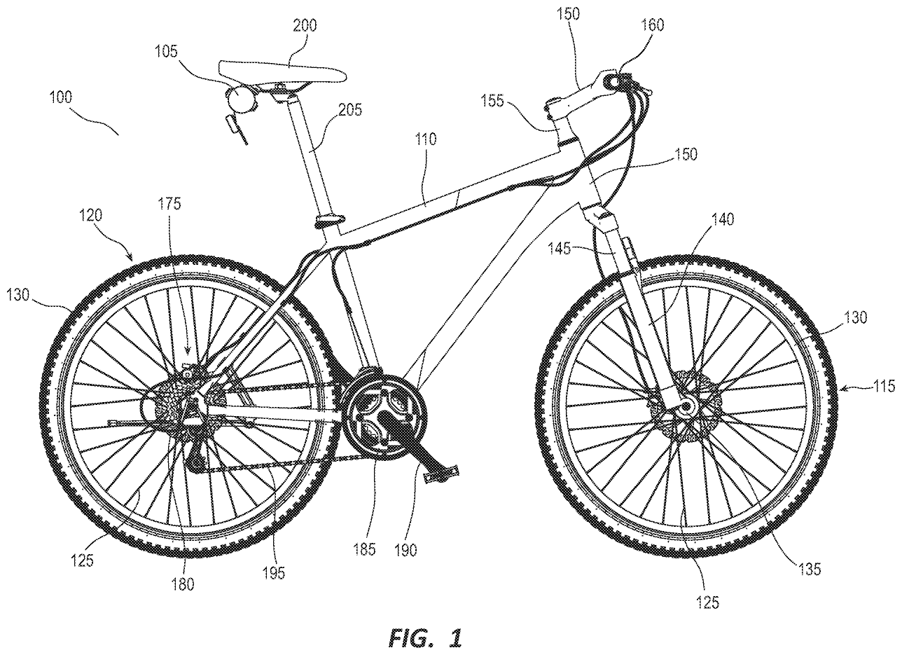

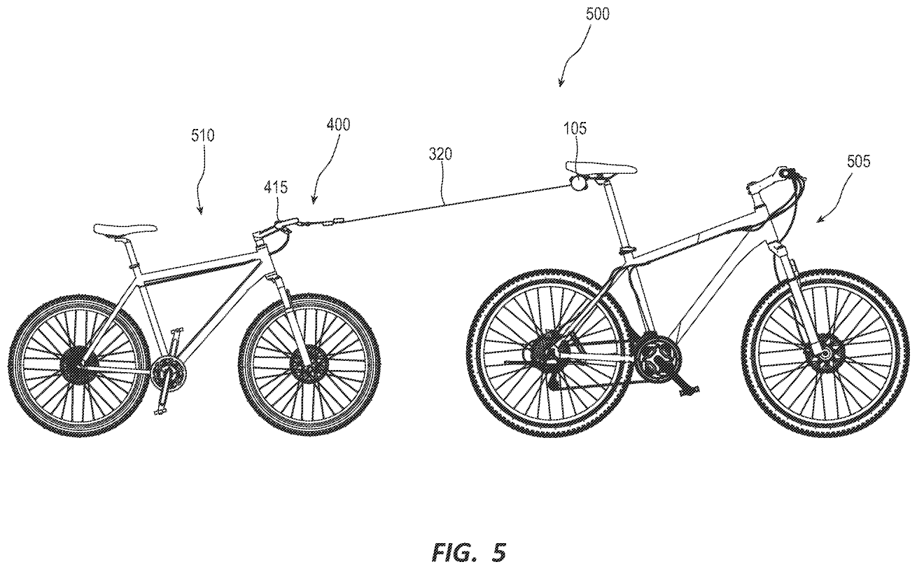

FIG. 1 is an example of a bicycle 100 that could be used with the exemplary tower device 105 for use in a towing system (e.g., tow system 500, FIG. 5). The bicycle 100 may be any type of bicycle, including a mountain bicycle, a road bicycle, touring bicycles, hybrid bicycles, cyclo-cross bicycle, utility bicycle, triathlon bicycle, snow bicycle, fixed gear bicycle, motorized bicycle, and the like. The bike may include a mainframe 110, a front wheel 115, and a rear-wheel 120. Various components of the bicycle 100 may function together to allow a cyclist to propel the bicycle 100 as desired. While the description in FIG. 1 is described in relation to a towing bike, the same elements and components may also relate to a towed bicycle.

The wheels 115, 120 may include multiple spokes 125. The spokes 125 may connect to a respective wheel rim 130 with one or more spoke nipples (not shown). The front spokes 125 may come together at a center point 135 of the front wheels 115, which may connect to a fork 140. In some embodiments, the fork 140 may include a shock 145. The fork 140 may attach to the mainframe 110 of the bicycle 100 at a steering tube or head tube 150. For example, the fork 140 may connect to a steering tube 150. The fork 140 may have. A stem 155 may be substantially cylindrical and may insert into and pass through a complimentary-sized substantially-cylindrical hollow-portion of the steering tube 150. The stem 155 may connect a handlebar system 160 to the steering tube 150 and allow a cyclist to steer the bicycle 100. The components may be one-piece components, inseparable assemblies, multi-piece assemblies, or the like. The exact configuration of the various components will depend on the type of bicycle and its purpose.

The rear spokes 125 may come together at a center point 175, where the mainframe 110 may connect to the rear wheel 120. A series of gears 180 may be proximate to the rear wheel 115 and may connect to a series of gears 185 proximate a pedal system 190 via a chain 195. A cyclist may use the pedal system 190 to propel the bicycle 100 in a desired direction at a desired pace. The cyclist may sit atop a saddle 200, which may be coupled to the mainframe 110 via a seat post 205. Various components of the bicycle 100 may not be disclosed in this elementary discussion of the main components of a typical bicycle. However, other components not discussed herein may be used in a bicycle assembly. The discussion herein is meant to provide a high-level overview of a bicycle. Different types of bicycles may have various additional and/or alternative components, and even the same class of bicycle will have various components based on manufacturer, cost, and the like.

At various times throughout biking, the user may need to utilize a tower device 105. The tower device 105 may be a part of a towing system 500 (see FIG. 5). The tower device 105 may be stored underneath the bicycle seat 200. By attaching the tower device 105 to the seat 200, the cyclist may continue to use a dropper post, a specially designed seat post that allows a user to change the seat height during use. If the towing device was attached to a dropper post, the towing device may prevent or hinder the use of the dropper post. In some instances, the tower device 105, when loaded, may also damage the dropper post. This may render the dropper post useless and require replacement, which is expensive.

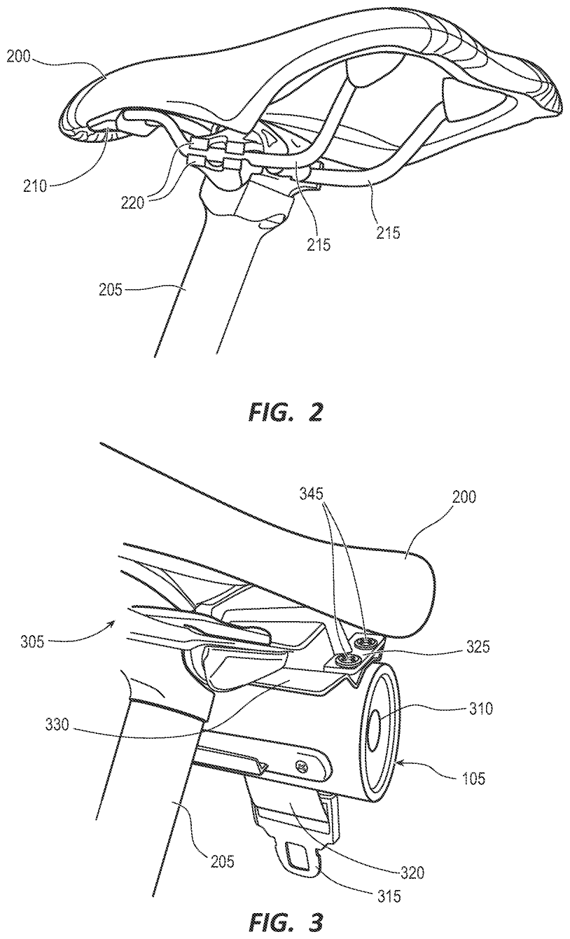

As seen in FIG. 2, the seat 200 comprises various components. The shell 210 creates the shape of the seat 200. The forward most part of the seat is the called the nose and is usually rounded. The shell 210 can be made from several materials but is typically a rigid component. Most seats also use some form of padding on top of the hard shell 210 (often closed cell foam, gel, or gel-foam) followed by an outer cover consisting of spandex, vinyl, artificial leather, or leather.

The rails 215 of the seat 200 connect the seat to the bicycle 100. The rails 215 run along an underside of the seat 200 from the nose to the rear. Most seats have two parallel rails that the seat post 205 clamps to, but seat designs may vary from one to four rails. Rails 215 provide fore and aft adjustment of the saddle, usually an inch or so. They can be made of solid or hollow steel, titanium, aluminum, manganese, or carbon fiber, typically trading off cost, weight, strength, and flexibility.

The part that connects the rails 215 to the seat post 205 is known as the saddle clamp 220. It may be built into the top of the seat post 205, or the seat post 205 may be essentially a pipe that provides a cylinder at the top for a separate clamp to attach. The upper attachment point must be compatible with the rail configuration, and the lower attachment point must match the diameter of the seat post if not built in.

FIG. 3 is a close-up view of tower device 105 coupled to an underside 305 of the seat. By attaching the tower device 105 to the seat 200, the bicycle post 205 retains its integrity. Therefore, a cyclist can continue using a desired seat post 205 without any interference. This includes using a dropper post, a common seat post used in mountain bicycling as discussed previously. A dropper post, also referred to as a dropper, is a replacement for a standard seat post and allows the cyclist to quickly adjust saddle height without dismounting or stopping. Most droppers work through cable actuation, although there are a handful of electronic/wireless posts.

The tower device 105 includes a retracting canister 310. The retracting canister 310 may include a pair of rotatable wheels inside the canister 310, which houses almost the entire length of the tow rope 320. When the tow rope 320 is pulled, extending it, the canister 310 ratchets lock automatically, preventing the tow rope 320 from rolling back up into its original storage position inside the canister 310. A snap of the wrist or the press of a button will disengage the ratchets, unlocking them and allowing the cord to retract back into place.

A towing latch 315 may be coupled to the two rope 320. The tow rope 320 may comprise a webbed nylon, a rope, a cord, metal twine, or another similar long, thin material that can be used for towing. The tow rope 320 should have a tensile strength capable of comfortably pulling the rider and bicycle. The latch 315 may comprise a clip, ring, carbineer, latch, or another removably coupling mechanism.

In some embodiments, the latch 315 may comprise a magnetic material or component. This may magnetically couple the latch 315 to a complimentary material proximate the outside of the canister 310. The canister 310 may also have a pocket or other envelope which may secure the latch 315 to the canister 310. Securing the latch 315 may prevent it from jostling or causing noise or distraction during a ride.

A top plate 325 may couple the canister 310 to the underside 305 of the seat 200. The top plate 325 may be a substantially planar, flat plate, or may contain linear indentations to couple to the seat's rails 215. In some embodiments, the top plate 325 may be substantially rectangular or any other shape that may fit between the bottom of the seat 200 and the rails 215.

The top plate 325 may be fastened to the canister 310. For example, one or more fasteners 345 may connect the top plate 325 to the canister 310. In some embodiments, the fastener(s) 345 may pass through the top plate 325 and connect to the canister 310. As the fasteners 345 are tightened, the rails 215 are clamped between the top plate 325 and the canister 310. The fasteners 345 may be bolts, screw, quick connect clamps, hinges, pins, and the like or some combination thereof. For example, in some embodiments, one end of the top plate 325 may be hindgedly connected to the canister 310 on a first end and the opposing end of the top plate 325 may be fastened to the canister 310. In some embodiments, the canister 310 may have a threaded component to receive a threaded fastener.

In some environments, the canister 310 may have a coupling plate 330 on the top side of the canister 310. The coupling plate 330 may have a substantially planer upper surface. The substantially planar surface of the coupling plate 330 may provide a flat surface for clamping the rails 215 between the coupling plate 330 in the top plate 325.

In some embodiments, the fastener(s) 345 may pass through the coupling plate 330 and fasten to the top plate 325. For example, the fastener(s) 345 may either fasten the coupling plate 330 and the top plate 310 together from the top side down or bottom side up

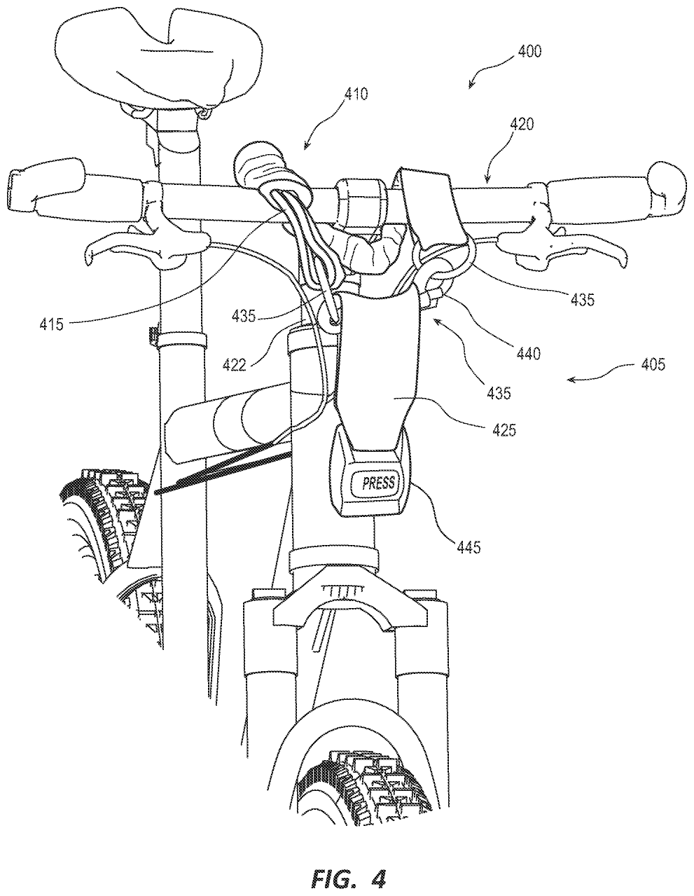

FIG. 4 is an exemplary embodiment of a towee system 400 for a second bicycle 405. The towee system 400 comprises an attachment mechanism 410 for removably coupling the first bicycle 100 to the second bicycle 405 as shown in FIG. 5.

Referring back to FIG. 4, in some embodiments, the towee system 400 has one or more towee straps 415 to attach the tower device 105 to the second bicycle 405. The one or more straps 415 may wrap around the handlebars 420 of the second bicycle 405. For example, the towee strap 415 may go over the top of the handlebars 420 on one side, around the stem 422, and under and over the top of the other side of the handlebars 420. In another embodiment, two straps 415 may be used and may attach to a respective side of the handlebars 420. Once the two strap 415 is hooked onto the bicycle 405, the towee strap 415 may couple to an attachment mechanism 430. The attachment mechanism 430 may be removably coupled to the towing rope 320 via one or methods. For example, the towee strap 415 may have one or more rings 435 or other attachment methods that removably couple to one or more clips 440. The clip 440 may include lobster clips, snap hooks, carabiner or similar coupling mechanism. In some embodiments, each ring 435 may couple to the same clip 440. The rings 435 may couple direction to the attachment mechanism 430 or there may be a second strap 425 between the ring and the attachment mechanism 430.

In some embodiments, the towee strap 415 may be flexible. For example, the towee strap 415 may consist of a bungie material. The stretchiness of the material may prevent jarring on the cyclist on the second cyclist. For example, if the connection had a non-flexible rope attachment, then as the towing cyclist is pulling the towee, the towee may get jarred as the tower is climbing. The stretchiness of the towee strap 415 may prevent this jarring motion. In other embodiments, any portion of the towee strap 415, second strap 425, or the tow rope 320 may be flexible. Incorporating the flexible portion along the towing system may provide for an enjoyable, smooth bicycle ride.

In some embodiments, the clip 440 may be coupled to a second coupling mechanism 445. The second coupling mechanism 445 may removably couple the towee system 400 to the tower device 105. In some embodiments, the second coupling mechanism 445 may include the buckle portion of a latch and buckle system. In other embodiments, the second coupling mechanism 445 may include the latch portion of the latch and buckle system and the towee system 400 may include the mating half. It will be appreciated that other types of connections systems may be used.

FIG. 5 is an exemplary embodiment of a tow system 500 fully assembled with a towing bicycle 505 and a towed bicycle 510. The towee strap 415 is a stretchy strap covered in nylon and attached to the handlebars and stem of the towed bicycle 510. The tow rope 320 is fully extended and in the towing position. The tower latch 315 is coupled to the towee latch 445. An effective towing force will be exerted on the towed bicycle 510 as the towing bicycle 505 pulls ahead by virtue of the rotary spring in strap cannister 310, and in the circumstance that the rope 320 is fully extended, the towing bicycle 505 directly tows the towed bicycle 510 and the force exerted may be greater than the spring force. The action of the rotary spring in the cannister prevents strap 103 from sagging and perhaps interfering with either of the bicycles or anything on the ground or road surface between the bicycles.

Once the cyclists have reached their destination, the latches 315, 445 may be disconnected and the tow rope 320 may retract into the canister 310. The towee system 400 may stay attached to the towed bicycle 510 or may be removed and stored in a backpack or other location proximate the cyclists.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and subcombinations of elements, features and acts or operations, which are regarded as novel and non-obvious. The claims also include elements, features and acts or operations that are equivalent to what is explicitly mentioned. Additional claims for other such combinations and subcombinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, the inventor(s) invoke 35 U.S.C. § 112(f) only when the words “means for” or “steps for” are expressly used in the claims. Accordingly, if these words are not used in a claim, then that claim is not intended to be construed by the inventor(s) in accordance with 35 U.S.C. § 112(f).

A person skilled in the art will be able to practice the present invention after careful review of this description, which is to be taken as a whole. Details have been included to provide a thorough understanding. In other instances, well-known aspects have not been described, in order to not obscure unnecessarily this description.

Some technologies or techniques described in this document may be known. Even then, however, it is not known to apply such technologies or techniques as described in this document, or for the purposes described in this document.

This description includes one or more examples, but this fact does not limit how the invention may be practiced. Indeed, examples, instances, versions or embodiments of the invention may be practiced according to what is described, or yet differently, and also in conjunction with other present or future technologies. Other such embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Incorporation by reference: References and citations to other documents, such as patents, patent applications, patent publications, journals, books, papers, web contents, have been made throughout this disclosure. All such documents are hereby incorporated herein by reference in their entirety for all purposes.

Parent patent applications: Any and all parent, grandparent, great-grandparent, etc. patent applications, whether mentioned in this document or in an Application Data Sheet (“A.D.S.”) of this patent application, are hereby incorporated by reference herein as originally disclosed, including any priority claims made in those applications and any material incorporated by reference, to the extent such subject matter is not inconsistent herewith.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and subcombinations of elements, features and acts or operations, which are regarded as novel and non-obvious. The claims also include elements, features and acts or operations that are equivalent to what is explicitly mentioned. Additional claims for other such combinations and subcombinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, the inventor(s) invoke 35 U.S.C. § 112(f) only when the words “means for” or “steps for” are expressly used in the claims. Accordingly, if these words are not used in a claim, then that claim is not intended to be construed by the inventor(s) in accordance with 35 U.S.C. § 112(f).

What is claimed is:

1. A towing device for a bicycle, the towing device comprising:
a tow rope retractably contained within a canister;
a mounting surface proximate a top of the canister;
at least one fastener positioned to affix the mounting surface to an underside of a bicycle seat.

2. The towing device of claim 1, further comprising:
a top plate removably coupled to the mounting surface via the one or more fasteners.

3. The towing device of claim 2, wherein the top plate has a first side and a second side opposite the first side, wherein the first side is hingedely coupled to the mounting surface and the second side is removably coupled to the mounting surface via the one or more fasteners.

4. The towing device of claim 1, further comprising:
a latch coupled to the tow rope.

5. The towing device of claim 4, wherein the latch comprises a magnetic material.

6. The towing device of claim 5, further comprising:
a magnet coupled to an outside of the canister, wherein the latch is removably coupled to the magnet.

7. The towing device of claim 1, wherein the mounting surface further includes a substantially planer mounting plate affixed to the canister.

8. The towing device of claim 1, wherein the at least one fastener includes a quick connect fastener.

9. A towing device for a bicycle, the towing device comprising:
a towee strap with a first end and a second end;
a first ring attached to the first end of the elasticized rope and a second ring attached to the second end of the towee strap;
the first and second ring coupled to a connector rope at a first end; and
a towing latch couple to the connector rope at a second end.

10. The towing device of claim 9, further comprising:
a clip proximate the first end of the second, rigid tow rope, wherein the clip removably couples to the first ring.

11. The towing device of claim 9, wherein the towee rope has a variable length.

12. The towing device of claim 9, further comprising a second towee strap.

13. The towing device of claim 9, wherein at least a portion of the towee strap comprises an elastic material.

14. The towing device of claim 13, further comprising:
a nylon cover covering the elasticized tow rope.

15. The towing device of claim 9, wherein the towing latch includes a clip, latch, or some combination thereof.

16. A towing system for a pair of bicycles, the towing device comprising:
a towing device comprising:
a tow rope retractably contained within a canister;
a mounting surface proximate a top of the canister;
at least one fastener positioned to affix the mounting surface to an underside of a bicycle seat;
a towing latching coupled to the free end of the tow rope;
a towee device comprising:
a second tow rope with a first end and a second end;
a first ring attached to the first end of the second tow rope and a second ring attached to the second end of the second tow rope;
the first and second ring coupled to a connecting tow rope at a first end; and
a second towing latch couple to the rigid tow rope at a second end, wherein the towing latch of the towee device removably couples to the towing latch.

17. The towing system of claim 16, further comprising:
a top plate; and
at least one fastener coupling the top plate to the canister.

18. The towing device of claim 17, wherein the top plate and at least one fastener clamps the canister to at least one seat rail of a bicycle.

19. The towing system of claim 16, wherein at least a portion of the first two rope is flexible.

20. The towing system of claim 16, wherein at least a portion of the second tow rope is flexible.
